(19) United States
(12) Patent Application Publication
(10) Pub. No.: US 2006/0042099 A1
(43) Pub. Date: Mar. 2, 2006

(54) " Kwik kut ", high performance " blade "

(76) Inventor: Eric David Diemert, Mobile, AL (US)

Correspondence Address: ERIC DAVID DIEMERT, 1625 WARDWOOD, MOBILE, AL, 36605, US

(21) Appl. No.: 10/929,084

(22) Filed: Aug. 30, 2004

(51) Int. Cl. B26B 9/00

(52) U.S. Cl. 30/346

(57) ABSTRACT

This new blade edge is designed to make the cold knifes' job, much easier. It consists of a hard metal, “L” shaped blade. That has holes to attatch it to the cold knife. Also this new idea consists of an edge that supercedes the original idea.

### BACK GROUND OF INVENTION

1] The field of the invention, comes from the use of a tool called a “cold knife” which is a tool, consisting of two handles, and a blade.

2] The description of the coldknife “blade”, would be a hard metal “L” shape blade, that fits into the coldknife. These blades are replacable.

3] The coldknife, is a tool that consist of two handles, connected by a cable. one handle holds the blade, the other one is used to pull with.

4] By placing the blade under the glass, you can pull it around by using the handles. This cuts the urethane, therefore, releasing the glass.

### SUMMARY OF INVENTION

1] My idea, gives a revolutionary edge, to the coldknife “blade”.
a] It cuts easier, while pulling evenly through, less urethane.
b] It's not as likely to damage the glass, while pulling through less urethane.
c] It stays sharper up to 4 times longer.
d] The installer does not have to tilt the coldknife.

2] This new edge will be evenly sharpened, similar to the edge of a pocket-knife.

3] This new blade will come in different sizes, and shapes.

4] This patent should also include, any reshaping the edge to the existing blade, that will, conflict with this idea.

### BRIEF DESCRIPTION OF DRAWINGS

FIG. 1-2 gives description of cold knife, and shows it's function.

FIG. 3,4-5 shows problems with existing blade edge.

FIG. 6 shows how existing edge can damage glass.

FIG. 7-8 shows new edge, and a clear difference, between old, and new design.

### DETAILED DESCRIPTION OF DRAWINGS

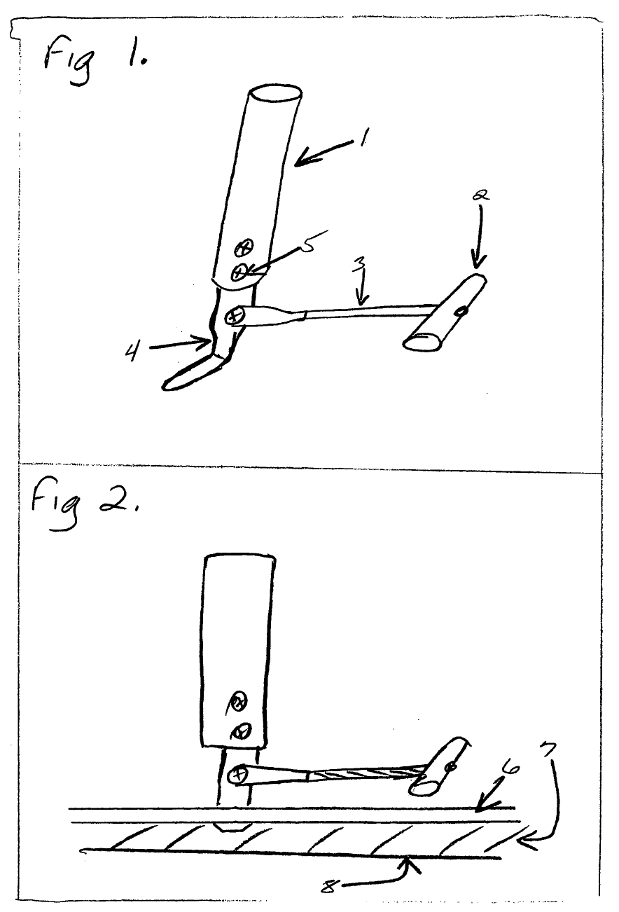

FIG. 1, is prior art, 1] handle 2] pull handle 3] cable 4] Blade 5] connecting-screws. FIG. 2, is prior art, 6] glass 7] urethane 8] is metal, pinchwield.

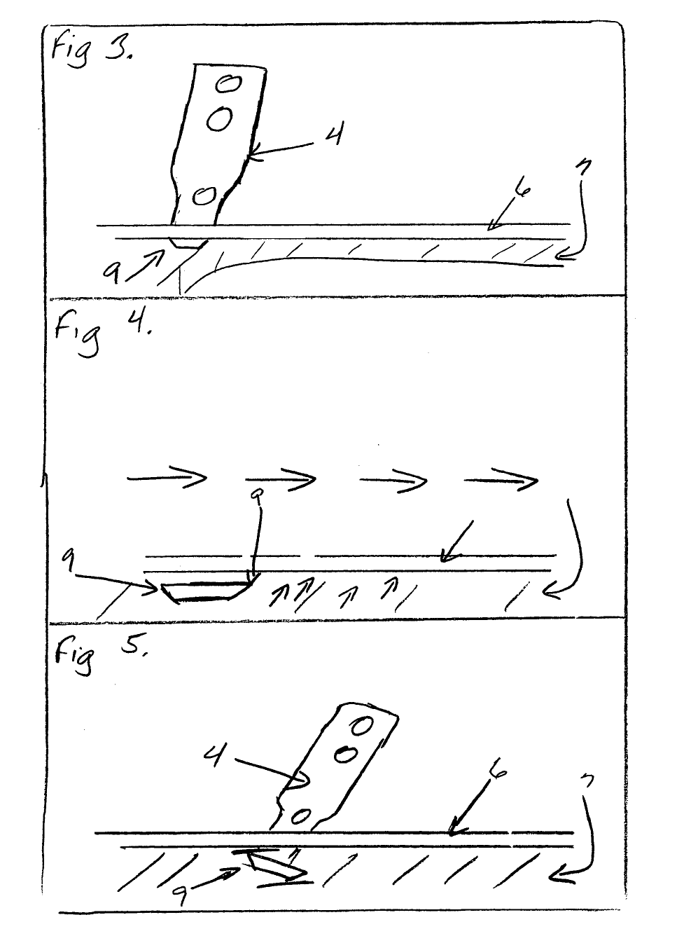

FIG. 3, is prior art, shows how blade was designed.

FIG. 4, is prior art, shows how edge wants to travel towards glass.

FIG. 5, is prior art, shows, when blade is tilted, how much more urethane, you have to pull through.

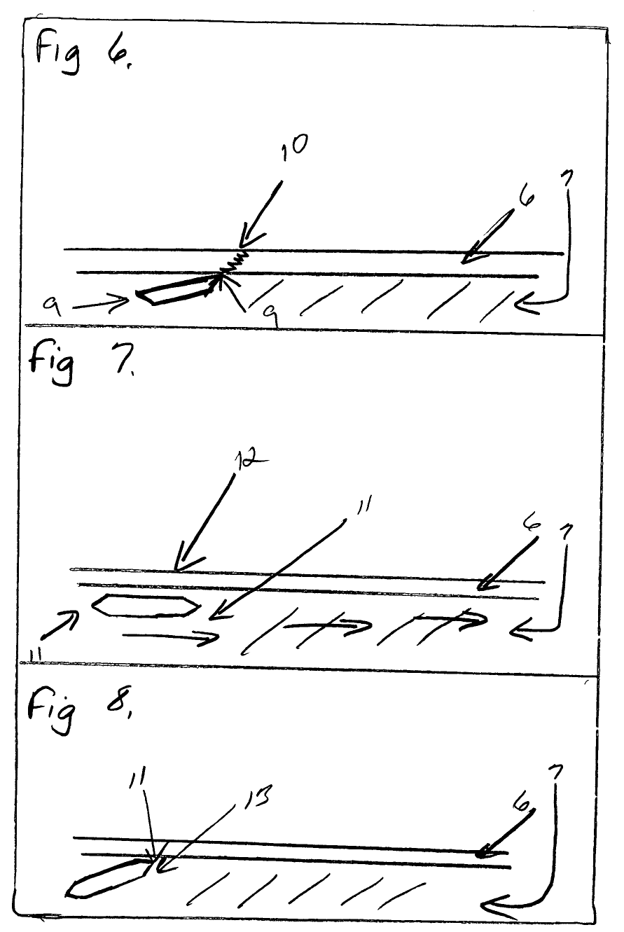

FIG. 7, is prior art, shows how a sharp edge can damage glass.

FIG. 7, is new edge design, shows how it travels straight.

FIG. 8, shows how a damaging edge is kept away from glass.
Also this keeps the edge sharper for longer.

What I now claim is:

1. My edge idea, is a better “high performance edge”, for the use in a “cold knife”. My edge, has the ability, to travel streight through urathane, with out getting stuck, or breaking out, or damage to the glass as easy. Also, traveling through less urathane, while keeping it's edge, sharper, up to four times longer.
